(19) United States
(12) Patent Application Publication
(10) Pub. No.: US 2025/0355912 A1
(43) Pub. Date: Nov. 20, 2025

(54) LARGE LANGUAGE MODEL (LLM)-BASED KNOWLEDGE RESOURCE RETRIEVER AND RANKER

(71) Applicant: SAP SE, Walldorf (DE)

(72) Inventors: Rohit Kumar GUPTA, Leimen (DE); Xuekai Du, Shanghai (CN); Debashis Ghosh, Mannheim (DE); Jens Trotzky, Shanghai (CN)

(21) Appl. No.: 18/668,685

(22) Filed: May 20, 2024

(51) Int. Cl. G06F 16/33; G06F 16/338; G06F 16/383; G06F 40/284

(52) U.S. Cl. CPC G06F 16/3344; G06F 16/338; G06F 16/383; G06F 40/284

(57) ABSTRACT

Disclosed herein are a system, method, and computer program product embodiments for retrieving and ranking knowledge resources relevant to a query from knowledge base(s). For example, a query for resources from knowledge base(s) may be received. Based on the query, a first set of candidate resources are obtained from the knowledge base(s) having a lexical similarity to the query search terms, and a second set of candidate resources are obtained from the knowledge base(s) having a semantical similarity to the search terms. For each of the first and second sets of candidate resources, a confidence level indicating the relevance of the candidate resource to the query is determined. The sets of candidate resources are ranked based on at least the confidence levels to generate a ranked list of candidate resources. A query response comprising at least a subset of the ranked list candidate resources is provided to a GUI.

### BACKGROUND

Retrieval systems have become an indispensable tool in the modern-day business environment for any company. It has to deal with the organization and extraction of business data from vast and complex information sources. Traditionally, retrieval systems use algorithms to index, search, and retrieve relevant business documents from large corpora based on specific user queries. A ranking system on top of it ensures that the users consistently find relevant information at the top of their search results by prioritizing them such that it is more likely to be found and used from many retrieved results.

However, with the exponential growth of digital information and the dynamic nature of business data, the retrieval of relevant documents becomes difficult. The temporal aspect adds another layer of complexity as the relevance of information often varies over time. For instance, a business user may have a query related to a software product whose different versions might exist over time, or for example, financial data from ten years ago may not be as relevant as the data from the previous fiscal year.

### BRIEF DESCRIPTION OF THE DRAWINGS

The accompanying drawings are incorporated herein and form a part of the specification.

FIG. 1 is a block diagram of a system configured to retrieve knowledge resources relevant to a query from one or more knowledge bases, according to some embodiments.

FIG. 2 depicts an example graphical user interface (GUI) screen for querying knowledge base(s), according to some embodiments.

FIG. 3 is a block diagram of a knowledge resource retriever, according to some embodiments.

FIG. 4 is a block diagram of a system configured to retrieve knowledge resources relevant to a search query, according to some embodiments.

FIG. 5 is a block diagram of a system for generating embeddings, according to some embodiments.

FIG. 6 is a block diagram of a ranker engine, according to some embodiments.

FIG. 7 is a block diagram of an aggregator, according to some embodiments.

FIG. 8 is a flowchart for a method for retrieving knowledge resources relevant to a query from knowledge base(s), according to some embodiments.

FIG. 9 is a flowchart for a method for obtaining a set of candidate resources, according to some embodiments.

FIG. 10 is a flowchart for a method for training language model(s), according to some embodiments.

FIG. 11 is an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

As discussed in the Background Section above, the retrieval of relevant documents becomes difficult given the vast number of documents and the age of such documents. These challenges necessitate the development of a robust and intelligent retrieval and ranking system that can handle complex business queries and provide effective solutions, which are in line with the business context provided.

An example of such a business area is customer support because it involves dealing with different customers directly to resolve the incidents they have encountered while using their products or services. Support engineers who work behind the scenes are the domain experts who control and drive the entire issue resolution process. The presence of such an intelligent retrieval and ranking system, which automatically understands the user's query and retrieves and ranks results in order of relevance, is pivotal in supporting decision-making processes, enhancing productivity, and ultimately driving business success. Customers can use such a system for self-service as well. The business value it adds is that it leads to faster resolution of incidents and prevents “re-inventing the wheel” by providing solutions that have been used in the past to resolve similar incidents, thus enabling reusability. It also saves the support engineer's time and effort.

Provided herein are a system, apparatus, device, method and/or computer program product embodiments, and/or combinations and sub-combinations thereof, for retrieving and ranking knowledge resources relevant to a query from one or more knowledge bases. For example, a query for knowledge resources from one or more knowledge bases may be received, where the query comprises one or more search terms. Based on the query, a first set of candidate resources are obtained from the one or more knowledge bases having a lexical similarity to the one or more search terms, and a second set of candidate resources are obtained from the one or more knowledge bases having a semantical similarity to the one or more search terms. For each of the first set of candidate resources and the second set of candidate resources, a level of confidence indicating the relevance of the candidate resource to the query may be determined. The first set of candidate resources and the second set of candidate resources may be ranked based on at least the level of confidence determined for each of the first set of candidate resources and the second set of candidate resources to generate a ranked list of candidate resources. For example, the ranked list of candidate resources may be re-ranked utilizing various metadata associated with the first set of candidate resources and the second set of candidate resources. A response to the query comprising at least a subset of the ranked list candidate resources may be provided to a graphical user interface for display thereby.

The techniques described herein improve the functioning of a computing system. For example, because the most relevant knowledge resources are recommended to a computing system, the computing system is no longer bombarded with hundreds or even thousands of knowledge resources (some of which that are not even applicable to the computing system). This advantageously conserves the network bandwidth of the computing device, as a lesser amount of knowledge resources are provided to the computing system. Moreover, the recommended knowledge resources are more likely to be applied in a timely fashion. By applying such knowledge resources, various issues (e.g., usability issues, performance issues, etc.) of the computing system are remedied, thereby enabling the computing system to run more efficiently. Accordingly, various compute resources (e.g., processor cycles, memory, storage, etc.) that are normally consumed from defective software are conserved as a result of timely applying such knowledge resources.

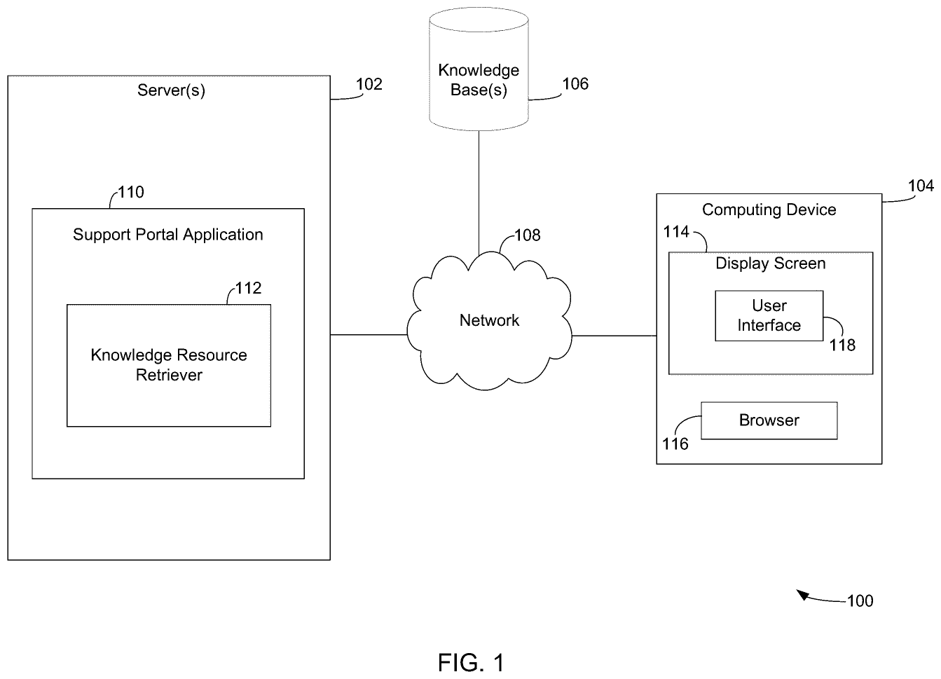

FIG. 1 shows a block diagram of a system 100 configured to retrieve knowledge resources relevant to a query from one or more knowledge bases, according to some embodiments. As shown in FIG. 1, system 100 includes one or more servers 102, a computing device 104, and one or more knowledge bases 106. Server(s) 102, computing device 104, and knowledge base(s) 106 may be communicatively coupled to each other via a network 108. Network 108 may comprise one or more networks such as local area networks (LANs), wide area networks (WANs), enterprise networks, the Internet, etc., and may include one or more of wired and/or wireless portions.

In an embodiment, server(s) 102 may form a network-accessible server set (e.g., a cloud-based environment or platform). Server(s) 102 may be accessible via network 108 (e.g., in a “cloud-based” embodiment) to build, deploy, and manage applications and services. Server(s) 102 may be co-located (e.g., housed in one or more nearby buildings with associated components such as backup power supplies, redundant data communications, environmental controls, etc.) to form a datacenter, or may be arranged in other manners. Accordingly, in an embodiment, server(s) 102 may be a datacenter in a distributed collection of datacenters.

Server(s) 102 may be configured to execute one or more software applications (or “applications”) and/or services. Server(s) 102 may also be configured for specific uses. For example, as shown in FIG. 1, server(s) 102 may be configured to execute a support portal application 110. Support portal application 110 may provide a search interface via which a user may search knowledge base(s) 106 for knowledge resources. The knowledge resources may provide solutions that address various software-related issues (e.g., security vulnerabilities, performance issues, bugs, etc.) with a software system (or a software component thereof) utilized by the user. Examples of knowledge resources include, but are not limited to, a software patch (or update) for the software system and/or component, a notification specifying a set of instructions that, when implemented, resolve a software-related issue for the software system and/or component. Examples of such patches and notifications include, but are not limited to, SAP® Notes, SAP® Security Notes, or various knowledge-based articles (KBAs). An example of a software system includes, but is not limited to, an enterprise resource planning software application that incorporates various business processes. Such business processes include, but are not limited to, operations (e.g., sales and distribution, materials management, production planning, logistics execution, and quality management), financials (e.g., financial accounting, management accounting, financial supply chain management, etc.), human capital management (e.g., training, payroll, recruiting, etc.), and corporate services (e.g., travel management, environment, health and safety, and real estate management). Examples of software components include, but are not limited to, services, plug-ins, application programming interfaces (APIs), libraries, etc.

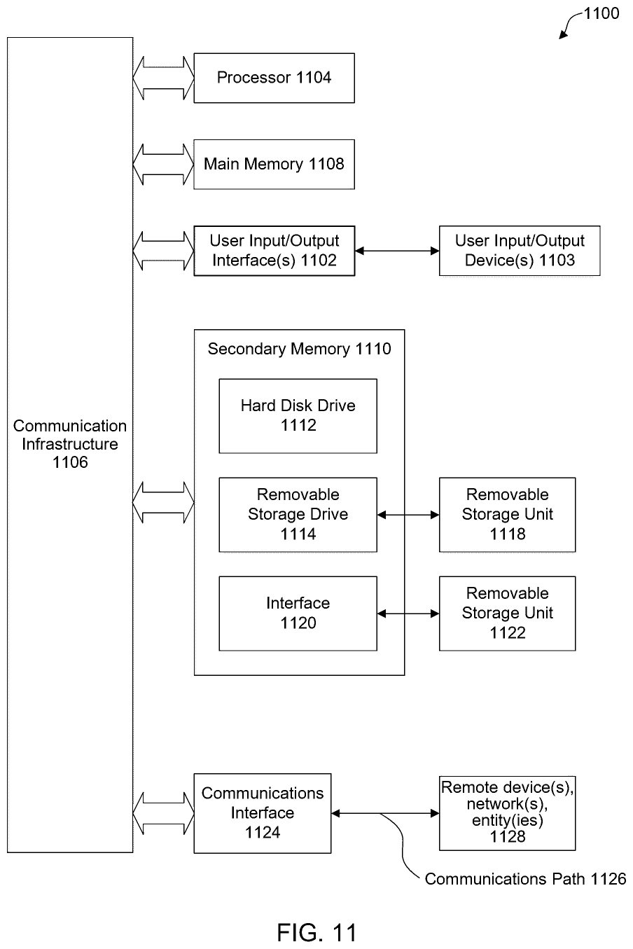

Knowledge base(s) 106 are intended to represent one or more databases that store various software patches, notifications, and/or KBAs. In an embodiment, knowledge base(s) 106 are managed by and accessed via a corresponding database management system (DBMS), which is not shown in FIG. 1 for the sake of simplicity. Knowledge base(s) 106 and the corresponding DBMS may be implemented on one or more computer systems, such as computer system 1100 as described below in reference to FIG. 11. Knowledge base(s) 106 and the corresponding DBMS may also be implemented on one or more servers of an enterprise network and/or a cloud computing network and accessed via a client computer system that is connected thereto, although these examples are not intended to be limiting.

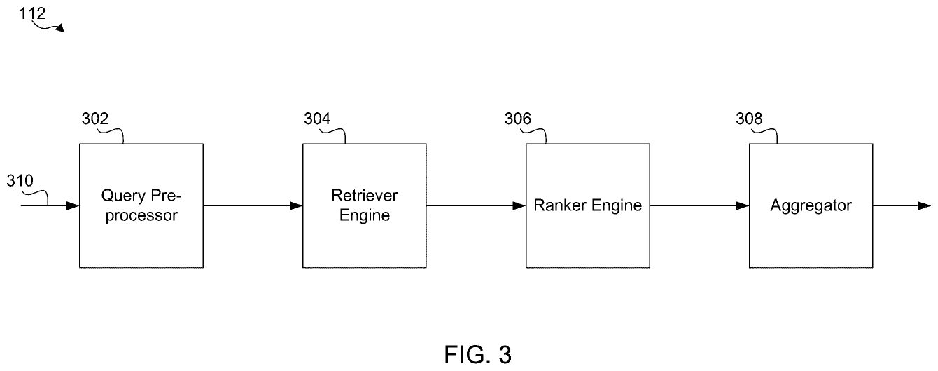

Knowledge resource retriever 112 may be configured to receive queries from a user and retrieve knowledge resources from knowledge base(s) 106 based on the queries. Knowledge resource retriever 112 may comprise a large language model (LLM)-based embedding model configured to transform natural language-based queries into a numeric form referred to as vector embeddings (or embeddings). During training, the LLM-based embedding model learns to encode a wide range of linguistic features, such as word meanings, sentence structures, and other higher-level concepts. Via training, the LLM-based embedding model acquires a deep understanding and captures the semantics of the information present in the text of a query. Knowledge resource retriever 112 may utilize a hybrid approach where both lexical and semantic aspects of the underlying text and language are leveraged to query knowledge base(s) 106. Additional details regarding knowledge resource retriever 112 are provided below with reference to FIGS. 3-7.

A user may access and/or utilize support portal application 110 via computing device 104. As shown in FIG. 1, computing device 104 includes a display screen 114 and a browser 116. A user may access and/or utilize support portal application 110 by interacting with an application at computing device 104 capable of accessing support portal application 110. For example, the user may use browser 116 to traverse a network address (e.g., a uniform resource locator) to support portal application 110, which invokes a user interface 118 (e.g., a web page) in a browser window rendered on computing device 104. By interacting with the user interface, the user may invoke support portal application 110. Computing device 104 may be any type of stationary device, such as a desktop computer or PC (personal computer), or mobile computing device (such as a laptop computer, a notebook computer, a tablet computer, etc.).

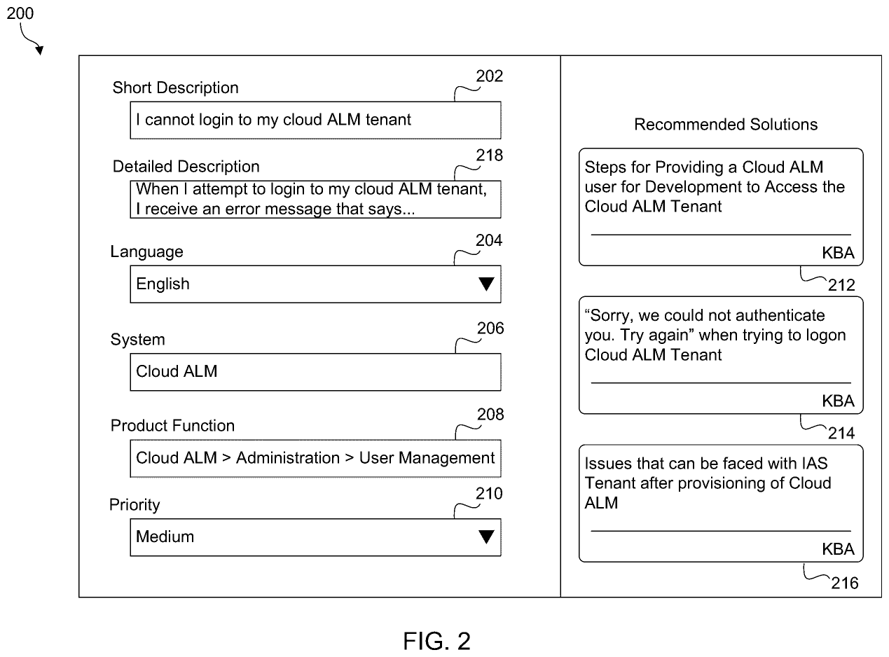

FIG. 2 depicts an example graphical user interface (GUI) screen 200 for querying knowledge base(s), according to some embodiments. As shown in FIG. 2, GUI screen 200 may comprise a plurality of user interface (UI) elements 202, 204, 206, 208, 210, and 218. UI element 202 comprises a text box that enables a user to enter a natural language-based query. UI element 218 comprises a text box that enables a user to enter a detailed description of the issue experienced by the user. UI elements 204, 206, 208, and 210 comprise various fields that enable a user to specify various filtering options for search results. For instance, UI element 204 enables a user to specify that the returned knowledge resources should in the English language, UI element 206 enables a user to specify which software system the returned knowledge resources should be associated therewith, UI element 208 enables a user to specify which function of the system specified via UI element 206 the returned knowledge resources should be associated therewith, and UI element 210 may specify which priority level the returned knowledge resources should be associated therewith. It is noted that the UI elements described above can be any type of UI elements and that the UI elements depicted in FIG. 2 are purely exemplary. It is also noted that such UI elements may enable a user to specify any type of filtering options and that the filtering options described above are purely exemplary.

As also shown in FIG. 2, GUI screen 200 may display various knowledge resources 212, 214, and 216 that are returned based on the query and associated filtering options. As shown in FIG. 2, three KBAs are returned. However, it is noted that this is purely exemplary and that any number and/or types of knowledge resources may be returned. Each of knowledge resources 212, 214, and 216 may be user-selectable. Upon selection of a particular knowledge resource, browser 116 may navigate to a web page that displays the selected knowledge resource. In an embodiment, search results may be presented via GUI screen 200 as auto-suggestions, where the results that are automatically returned and refreshed as the user types the query.

FIG. 3 is a block diagram of knowledge resource retriever 112, according to some embodiments. Knowledge resource retriever 112 may be implemented by processing logic that can comprise hardware (e.g., circuitry, dedicated logic, programmable logic, microcode, etc.), software (e.g., instructions executing on a processing device), or a combination thereof. In an embodiment, knowledge resource retriever 112 is implemented in one or more software processes executing on one or more processor-based computer systems, such as computer system 1100 as described below in reference to FIG. 11. As shown in FIG. 3, knowledge resource retriever 112 may include a query pre-processor 302, a retriever engine 304, a ranker engine 306, and an aggregator 308. Each of these components are described below.

Query pre-processor 302 may be implemented by processing logic that can comprise hardware (e.g., circuitry, dedicated logic, programmable logic, microcode, etc.), software (e.g., instructions executing on a processing device), or a combination thereof. In an embodiment, query pre-processor 302 is implemented in one or more software processes executing on one or more processor-based computer systems, such as computer system 1100 as described below in reference to FIG. 11. Query pre-processor 302 may be configured to pre-process a query 310 (e.g., entered via UI element 202) and knowledge resources stored by knowledge base(s) 106. Query 310 may comprising one or more search terms. In the example shown in FIG. 2, the query entered via UI element 202 comprises the following search terms: “I,” “cannot,” “login,” “to”, “my,” “cloud,” “ALM,”, and “tenant.”

Query pre-processor 302 may be configured to pre-process query 310 and knowledge resources in various ways, including, lexical pre-processing and semantic pre-processing. With regards to lexical pre-processing, a distinctive characteristic of contemporary business text data is the frequent deviation from standard natural language, particularly in terms of vocabulary. The deviation is primarily observed in two aspects, which are described below. The first aspect is the utilization of a non-standard lexicon. In many business contexts, specific words and phrases acquire unique meanings, diverging from conventional language. A common occurrence is the use of non-dictionary terms that lack standardized spelling and are subject to individual preference. For example, the term “U-ID” within a corporate environment might signify various identifiers, such as “Unique ID,” “Universal ID,” or “User ID.” Its representation may vary, appearing as “U_ID,”, “U-ID,” or simply “UID.” Traditional lexical algorithms, such as a Best Matching 25 (BM25)-based algorithm, often fail to effectively interpret these variations. The second aspect is the re-contextualization of a standard lexicon. Business language frequently re-purposes common dictionary words, assigning them specific, context-driven meanings. For instance, consider the compound term “install component,” which, in a given business setting, might refer to a 32-digit hash representing an installed product. Although the words “install” and “component” are individually commonplace, their combined usage in this context conveys a specific, non-obvious meaning, which is not readily decipherable by standard lexical search methods.

To address these issues, query pre-processor 302 may perform lexical pre-processing on query 310 and knowledge resources by normalizing non-standard terms and consolidating context-specific phrases. For example, to normalize non-standard terms, query pre-processor 302 may transform non-dictionary words (e.g., words that are not found in a dictionary) to a standardized root form to ensure uniformity. For example, “U-ID” (and its various manifestations) may be normalized to “uid.” To consolidate context-specific phrases, query pre-processor 302 may identify and merge frequently co-occurring phrases into single terms. This process transforms compound terms such as “install component” into a concatenated form (e.g., “installcomponent”), and integrates them into the search corpus as enhanced lexical entities. These pre-processing steps enable knowledge resource retriever 112 to effectively match and interpret business-specific language variations, significantly improving the accuracy and relevance of results with lexical searching algorithms.

To perform semantic pre-processing, query pre-processor 302 may utilize various advanced semantic techniques, including, but not limited to an encoder stack of a transformer-based model. Such a model may be utilized when conventional lexical algorithms are not sufficient to bridge the gap between query 310 and the data corpus (e.g., the knowledge resources of knowledge base(s) 106). The transformer model may divide the text into tokens, which can be words, phrases, sub-words, or characters. This process, known as tokenization, splits the text into its smallest meaningful units. This is the basic step towards semantic pre-processing. Query pre-processor 302 may utilize a selective approach to determine which words should be split into granular tokens. Commonly used words remain intact, while less frequent words are divided into meaningful sub-words. For example, the word “sportingly” may be split into “sport,” “ing,” and “ly” assuming that “sportingly” is not frequently used in the training corpus. However, the word “sport” may be frequently used and remains unchanged, while “ingly” is less common and is decomposed.

Query pre-processor 302 may also be configured to understand the semantic relationship between words such as “token,” “tokens,” “tokenization,” and “tokenizing,” which share the root “token.” Once query pre-processor 302 identifies the root of a word, query pre-processor 302 splits the sub-words accordingly. While query pre-processor 302 may rely on usage frequency to split a word into sub-words, it may not be sufficient for capturing compound words, such as “SuccessFactors,” “datapath,” and “Fieldglass.” To preserve their inherent meaning, query pre-processor 302 may utilize an additional technique to keep these compound words intact. For instance, query pre-processor 302 may combine the tokens generated by both steps to create a set of domain-specific tokens.

Query pre-processor 302 may be trained utilizing a text corpora comprising knowledge resources including, but limited to SAP® Notes, SAP® Security Notes, various knowledge-based articles (KBAs), incident reports, product documentation, etc. Such knowledge resources may be stored in knowledge base(s) 106. Conventional tokenization techniques may not be utilized, as they mostly are configured to tokenize English words and lack business-specific terminologies (e.g., S4/HANA, Web Dynpro, Badi, BAPI, Fieldglass, 2TV, etc.). These terms do not have direct English representations. The rules used to train query pre-processor 302 follow a deterministic process, allowing for easy adoption in other business domains. This semantic approach, when integrated with lexical pre-processing (as described above), provides a comprehensive and sophisticated search capability, significantly enhancing the accuracy and relevance of search results in specialized business contexts.

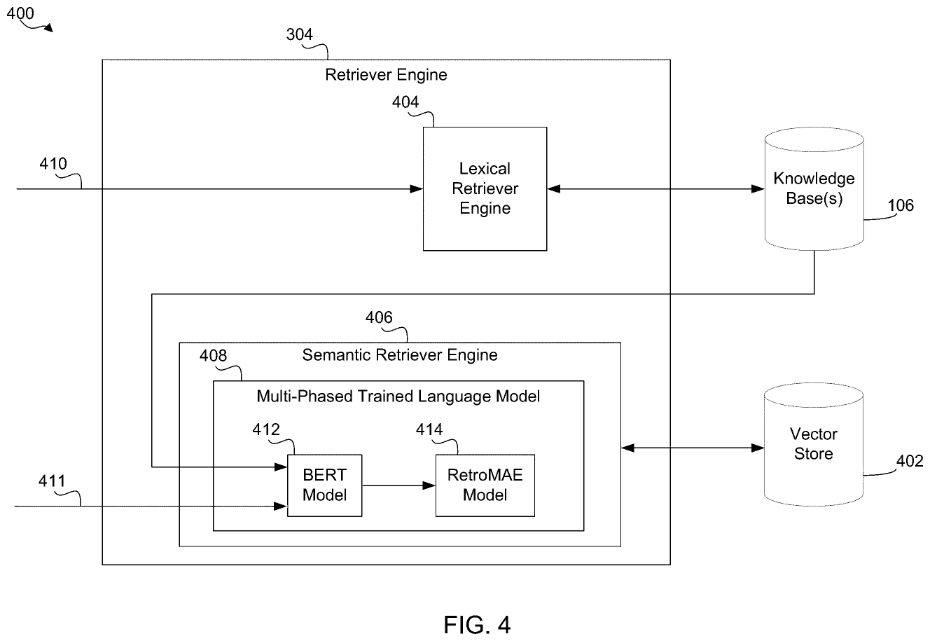

The tokens generated based on the search terms of query 310 are provided to retriever engine 304. Retriever engine 304 may be implemented by processing logic that can comprise hardware (e.g., circuitry, dedicated logic, programmable logic, microcode, etc.), software (e.g., instructions executing on a processing device), or a combination thereof. In an embodiment, retriever engine 304 is implemented in one or more software processes executing on one or more processor-based computer systems, such as computer system 1100 as described below in reference to FIG. 11. Retriever engine 304 may be configured to retrieve relevant knowledge resources (e.g., from millions of different knowledge resources) from knowledge base(s) 106. Retriever engine 304 may utilize a combination of lexical and semantic retrieval techniques. This hybrid retrieval technique helps to handle the dynamic nature of incoming queries. In certain cases, lexical retrieval is beneficial when query 310 lacks context and is ambiguous in nature. It helps to retrieve the precise information based on the specific terms used in query 310, without requiring a deep understanding of the underlying problem concept. On the other hand, a semantic retrieval goes beyond the literal meaning of words and takes into account the context and meaning of query 310. It aims to understand the intent behind query 310 and retrieve information that is conceptually related and semantically similar to query 310. Retriever engine 304 may output a concatenated set of retrieved results (comprising knowledge resources retrieved using lexical retrieval and knowledge resources retrieved using semantic retrieval) and different lexical and functional scores. The lexical score may indicate how lexically relevant a particular retrieved knowledge resource is to query 310. The functional score may be indicative of how different attributes match different solutions. The retrieved knowledge resources may be provided to ranker engine 306. The associated scores may be provided to aggregator 308. Additional details regarding retriever engine 304 are provided below with reference to FIG. 4.

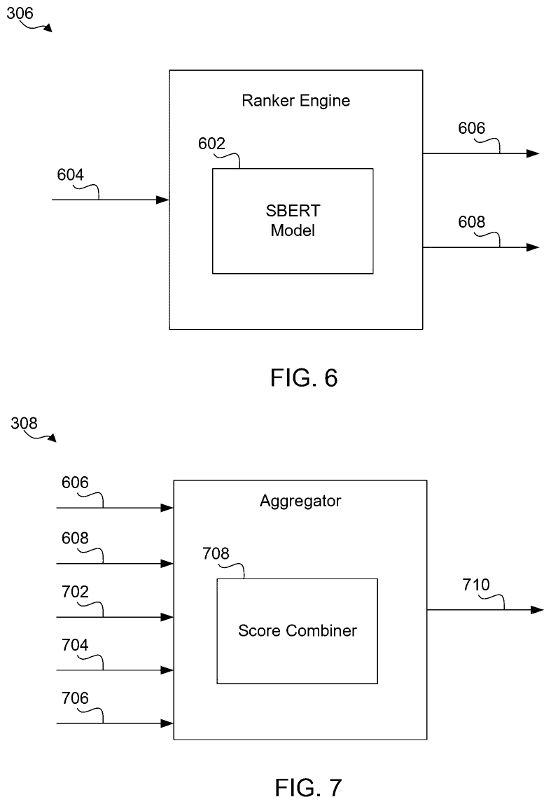

Ranker engine 306 may be implemented by processing logic that can comprise hardware (e.g., circuitry, dedicated logic, programmable logic, microcode, etc.), software (e.g., instructions executing on a processing device), or a combination thereof. In an embodiment, ranker engine 306 is implemented in one or more software processes executing on one or more processor-based computer systems, such as computer system 1100 as described below in reference to FIG. 11. Ranker engine 306 may be configured to refine the retrieved results in order of relevance, computing a confidence score for each refined result (also referred to as a refined candidate). This score indicates the level of confidence in the ability of knowledge resource retriever 112 to resolve the given query (e.g., query 310). The refined candidates and the confidence score may be provided to aggregator 308. Additional details regarding ranker engine 306 are provided below with reference to FIG. 6.

Aggregator 308 may be implemented by processing logic that can comprise hardware (e.g., circuitry, dedicated logic, programmable logic, microcode, etc.), software (e.g., instructions executing on a processing device), or a combination thereof. In an embodiment, aggregator 308 is implemented in one or more software processes executing on one or more processor-based computer systems, such as computer system 1100 as described below in reference to FIG. 11. Aggregator 308 may be configured to combine the various retrieval scores obtained from retriever engine 304 and confidence scores obtained from ranker engine 306 in a weighted average manner, where each of the scores are weighed in a preconfigured manner. By doing so, both the lexical and semantic nuances are captured, thereby forming a hybrid mechanism for retrieving knowledge resources. Additional details regarding ranker aggregator 308 are provided below with reference to FIG. 7.

FIG. 4 is a block diagram of a system 400 configured to retrieve knowledge resources relevant to a search query, according to some embodiments. As shown in FIG. 4, system 400 includes retriever engine 304, knowledge base(s) 106, and a vector store 402. Vector store 402 is intended to represent one or more databases that store vector embeddings representative of the knowledge resources stored in knowledge base(s) 106. In an embodiment, vector store 402 is managed by and accessed via a corresponding database management system (DBMS), which is not shown in FIG. 4 for the sake of simplicity. Vector store 402 and the corresponding DBMS may be implemented on one or more computer systems, such as computer system 1100 as described below in reference to FIG. 11. Vector store 402 and the corresponding DBMS may also be implemented on one or more servers of an enterprise network and/or a cloud computing network and accessed via a client computer system that is connected thereto, although these examples are not intended to be limiting.

Lexical retriever engine 404 may be configured to receive queries 410 that have undergone lexical pre-processing by query pre-processor 302. Lexical retriever engine 404 may utilize various lexical search algorithms, such as term frequency-inverse document frequency (TF-IDF)-based algorithms and BM25-based algorithms to retrieve knowledge resources. For example, when utilizing a TF-IDF-based algorithm, lexical retriever engine 404 may return knowledge resources based on a how many times a word of query 410 appears in a particular knowledge resource and based on how common (or rare) the word is across all knowledge resources. When utilizing a BM25-based algorithm lexical retriever engine 404 may return knowledge resources utilizing a bag-of-words retrieval function that ranks a set of knowledge resources based on the query terms of query 410 appearing in each knowledge resource, regardless of their proximity within the knowledge resource. By utilizing such techniques, lexical retriever engine 404 aligns queries 410 with the most relevant knowledge resources in the corpus stored by knowledge base(s) on a lexical basis. This results in a ranked list of knowledge resources, ordered by their lexical relevance to query 410, ensuring that the top results closely correspond to the user's search intent.

To enhance this retrieval process further, lexical retriever engine 404 also integrates additional contextual signals inherent in knowledge resources. These signals include, but are not limited to, recency (indicating that newer knowledge resources may be more relevant) and internal corporate classifications such as product categories. This forms the functional aspect of query 410 and the matched solution. By incorporating these factors, along with the lexical matching scores, a more nuanced and comprehensive retrieval is achieved. This multifaceted approach not only leverages textual information, but also considers various business-specific attributes, leading to significantly improved relevancy. The list of knowledge resources found lexically relevant to query 310 may be provided to ranker engine 306.

When results for a query are retrieved based on the lexical match (e.g., based on n-gram tokens between query text and text corpus), it lacks the semantic aspect of matching the knowledge resources. For example, consider the following two sentences: “Kindly attach salary statement” and “Please include payslip details.” Even though there are no matching words between the two texts or are any similar n-gram tokens, both sentences have the same semantic meaning.

Semantic retriever engine 406 may comprise a multi-phased trained language model 408 comprising one or more language models. In an embodiment, the language model(s) comprise transformer-based models, including, but not limited to, a Bidirectional Encoder Representations from Transformers (BERT) model 412 and a Retrieval-Oriented Language Models via Masked Auto-Encoder (RetroMAE) model 414. BERT model 412 may be pre-trained on text corpora, such as knowledge resources stored by knowledge base(s) 106. The primary object of pre-training is to create a model that can generate embeddings for domain-specific text (i.e., the knowledge resources) at a relatively small granularity (e.g., embeddings on a word-by-word or sentence-by-sentence basis). Masked language modeling (MLM) may be the underlying technique utilized to pre-train BERT model 412. In this approach, semantic retriever engine 406 may be configured to randomly mask a predetermined percentage (e.g., 20%) of words in a given knowledge resource and train BERT model 412 to predict the missing words and generate embeddings accordingly. This may be performed on a sentence-by-sentence basis for each of the knowledge resources. In an embodiment, a higher proportion of masking may be utilized than compared to conventional approaches. In further contrast to conventional approaches, semantic retriever engine 406 masks words rather than tokens. To predict a masked word, BERT model 412 may consider the contextual information from both the left and sides of the masked word (i.e., the words that are proximate and adjacent to the masked word). In this process, BERT model 412 learns better a better embedding representation for each word in the text. For example, consider the following sentence: “refresh cannot be submitted because the data volume of source is too large.” In this example, suppose that the words “submitted,” “data,”, and “large” are randomly masked. BERT model 412 may be configured to determine these masked words using the words adjacent thereto. The word embeddings generated by BERT model 412 are provided to RetroMAE model 414, which enhances the quality of the embeddings provided by BERT model 412. Particularly, RetroMAE model 414 may generate an embedding representative of each knowledge resource, rather than just a word or sentence included in a knowledge resource.

RetroMAE model 414 may be configured to retrain the embeddings received from and generated by the encoder of BERT model 412. While the encoder of BERT model 412 generates embeddings for words of an input sentence, a decoder of RetroMAE model 414 may reconstruct an input sentence based on the embeddings of BERT model 412.

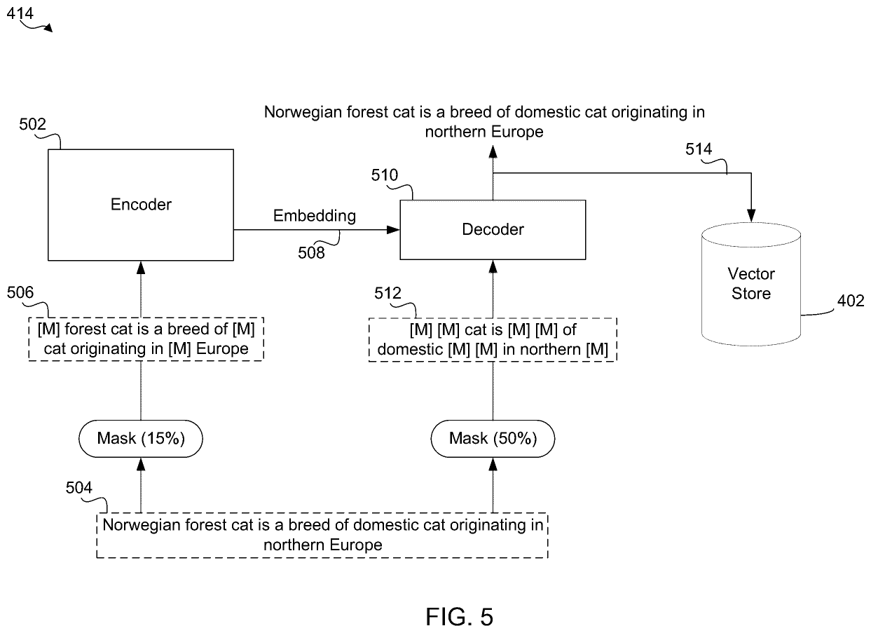

For instance, FIG. 5 is a block diagram of a system 500 for generating embeddings using a BERT model and a RetroMAE model, according to some embodiments. As shown in FIG. 5, system 500 includes an encoder 502 of BERT model 412 and a decoder 510 of RetroMAE model 414. As described above, encoder 502 generates embeddings for each word of input sentence 504. A certain percentage of words (e.g., 15-30%) of input sentence 504 are randomly masked to generate a first masked sentence 506. First masked sentence 506 is provided as an input to encoder 502, which predicts the masked words and generates a sentence embedding 508 based thereon. Sentence embedding 508 is provided to decoder 510. Decoder 510 may be configured to reconstruct input sentence 504 based on sentence embedding 508. For instance, a certain percentage of words of input sentence 504 are randomly masked to generate a second masked sentence 512. Second masked sentence 512 is provided as an input to decoder 510. Decoder 510 learns to predict and generate the complete text using embedding 508. As shown in FIG. 5, the masking ratios (i.e., the masking percentage) utilized to mask a sentence input into encoder 502 may be asymmetric, with the sentence being input to encoder 502 being masked at a moderate ratio (e.g., 15-30%) and the sentence being input to decoder 510 being masked at a more aggressive ratio (e.g., 50-70%). The asymmetric masking ratios enable the auto-encoding task to be more demanding on encoding quality, thereby ensuring that training signals are generated from most input tokens. Using this training process, RetroMAE model 414 generates embeddings 514 each representative of a particular knowledge resources. Such embeddings 514 are stored in vector store 402.

Referring again to FIG. 4, semantic retriever engine 406 may be configured to receive queries 411 that have undergone semantic pre-processing by query pre-processor 302. When a query 411 is received, multi-phased trained language model 408 may generate an embedding representative of query 410 in a similar manner described above with respect to the embeddings generated for knowledge resources. Using the embedding, semantic retriever engine 406 searches vector store 402 for knowledge resource embeddings that are similar (e.g., based on a cosine similarity between query embedding and the knowledge resource embeddings). In an embodiment, a Hierarchical Navigable Small World (HNSW)-based search algorithm (which is a type of a nearest neighbor search algorithm) may be used to search for relevant knowledge resources. Each knowledge resource embedding in vector store 402 may be represented by a multi-dimensional vector (e.g., a 768-dimensional vector). For larger datasets with higher dimensions, it has been observed that generating an HNSW index provides significant performance. The HNSW index may comprise HNSW graphs that are constructed by breaking down Navigable Small World (NSW) graphs into multiple layers, with each subsequent layer removing the intermediate links between the vertices representing knowledge resource embeddings. The top-most (or entry) layer may include the longest links, whereas the bottom-most layer (e.g., layer 0) may include the shortest links. During the search, the top-most layer is analyzed to find the longest links. The associated vertices tend to be higher-degree vertices (with links separated across multiple layers). Edges may be traversed in each layer, greedily moving to the nearest vertex until a local minimum is found. Then, the search process is repeated with the current vertex for each of the lower layers until the local minimum is located in the bottom-most layer (i.e., layer 0). The list of knowledge resources found semantically relevant to query 410 may be provided to ranker engine 306.

FIG. 6 is a block diagram of ranker engine 306, according to some embodiments. Ranker engine 306 may be configured to refine the list of relevant candidate knowledge resources (shown as resources 604) provided by retriever engine 304, which may fetch the top 50-100 potentially relevant (or candidate) knowledge resources from millions of knowledge resources. Given that users are not expected to sift through all these potential results, ranker engine 306 further refines these retrieved results. Ranker engine 306 determines the order in which the knowledge resources or search results are shown to users in response to their queries. It does so by calculating a level of confidence (or confidence score) that signifies the relevance of the retrieved knowledge resource to the user's query. It is a complex task, as it must identify the most pertinent knowledge resource(s) among an already relevant set of retrieved knowledge resources. Ranker engine 306 ranks the candidate knowledge resources based on the level of confidence of the candidate knowledge resources and provides the ranked candidate knowledge resources (shown as ranked candidate resources 606) and levels of confidence 608 to aggregator 308.

To handle this complex task, ranker engine 306 may create pairs of query and knowledge resource sentences and determine their similarity. The similarity score represents the confidence level of the knowledge resource's relevance to the query. Ranker engine 306 may utilize a sentence BERT (SBERT) model 602 to generate the confidence score. To train SBERT model 602, a dataset with known similarity scores are utilized. In the field of Customer Support, ranker engine 306 may form pairs of incident and resolution texts from historical data of customer incidents that are already resolved. Positive pairs may have a similarity score of one, while negative pairs may have a similarity score of zero. During the resolution phase, there may be solutions that were considered relevant and proposed, but did not resolve the customer's issue. Such solutions form negative pairs. This enables ranker engine 306 to create both positive and negative pairs for training SBERT model 602 to identify sentence similarity.

SBERT model 602 may generate word embeddings for each word in a sentence in each incident report and a resolution report. A mean pooling layer of SBERT model 602 may determine the mean (or average) of these embeddings. The sentence embeddings of the individual sentences are used to compute the similarity there between (e.g., a cosine similarity between the embeddings). SBERT model 602 may comprise a pairwise loss function (e.g., a multiple negative ranking symmetric loss function). Such a loss function utilizes the predicted similarity and known ground truth similarity scores to determine the correct rank of positive solutions within a batch of paired sentences. It is symmetric because it additionally computes the loss to find the incident for a given solution.

FIG. 7 is a block diagram of aggregator 308, according to some embodiments. Aggregator 308 may be configured to receive ranked candidate resources 606 and associated levels of confidence 608 from ranker engine 306. Aggregator 308 may also be configured to receive lexical scores 702 associated with candidate knowledge resources retrieved by lexical retriever engine 404 and functional scores 704 associated with candidate knowledge resources retrieved by semantic retriever engine 406. Aggregator 308 may also be configured to retrieve various metadata 706 associated with ranked candidate resources 606. Such metadata 706 includes, but is not limited to, an age (e.g., publication date) of each candidate knowledge resource of ranked candidate resources 606 and a usage frequency of each candidate knowledge resource of ranked candidate resources 606 (e.g., how frequent such candidate knowledge resource is viewed and/or implemented). Such metadata may be associated with each candidate knowledge resource in knowledge base(s) 106 or via another database. Such metadata may be represented as a numerical value or score.

Aggregator 308 may comprise a score combiner 708 configured to associate a weight to each of scores 608, 702, 704, and/or metadata 706 and combine the weighted scores. For instance, score combiner 708 may combine such scores utilizing a weighted average to determine a final hybrid score. The final hybrid score is utilized to re-order the candidate resources to generate a re-ordered list of candidate resources 710, where candidate knowledge resources with the relatively higher final hybrid scores are provided as search results first. The re-ordered list of candidate resources 710 is provided as search results to the user.

In an embodiment, to determine the weights of each score, aggregator 308 may utilize a decision tree feature importance calculation. Aggregator 308 may collect both positive and negative data samples, similar to ranker engine 306. For each data point, aggregator 308 treats various scores as features to classify between the positive and negative samples. The tree-based method evaluates how much these scores contribute to resolving uncertainty and accurately classifying the samples. This assessment of scores provides the weights utilized for the final hybrid score.

The techniques described herein may be utilized across various cases pertaining to customer support. For instance, such techniques may be utilized for incident-to-solution matching. Knowledge base(s) 106 may store all customer incidents and the solutions provided by experts. As the support colleague creates a large number of solutions over time, this framework automatically recommends accurate and relevant solutions to customers and support colleagues based on the problem description (e.g., entered by the user via a query). This significantly speeds up issue resolution compared to the traditional method of manually searching and analyzing documents to propose solutions.

Such techniques may also be utilized for incident-to-incident matching. Support colleagues often face the challenge of identifying similar incidents from a large collection in order to better serve customers. This involves searching through a vast number of customer messages, which can be a time-consuming task. However, the framework described herein simplifies this process for support organizations. By utilizing knowledge resource retriever 112, similar incidents may be identified in a more efficient manner.

Such techniques may further be utilized for solution-to-solution matching. The initial step for support engineers in creating innovative solutions is to search knowledge base(s) 106 for existing solutions. This process is crucial for identifying and addressing specific problem types. Knowledge resource retriever 112 can be utilized to efficiently identify similar solutions.

Such techniques may also be utilized for component prediction. For larger organizations with many products, it is essential to tag each product with a particular component for faster resolution of the issue. When a customer raise an issue, the customer should identify the correct component from where the issue emits. Those issues may be channeled to the experts that are tagged to the components for faster resolution. Knowledge resource retriever 112 may identify the correct component more accurately, as tagging a wrong component increases the issue resolution time.

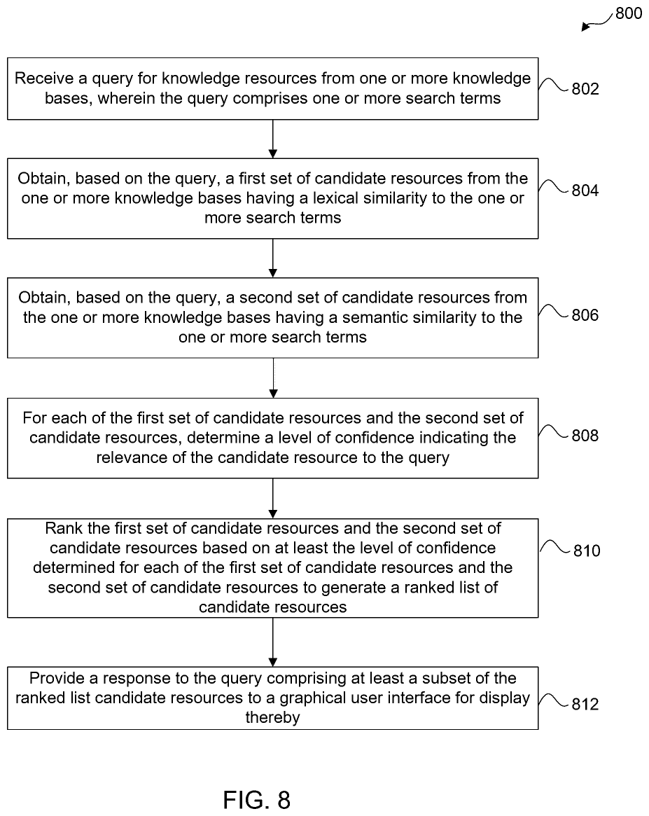

FIG. 8 is a flowchart for a method 800 for retrieving knowledge resources relevant to a query from knowledge base(s), according to some embodiments. Method 800 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 8, as will be understood by a person of ordinary skill in the art.

Method 800 shall be described with reference to FIGS. 1-4, 6, and 7. However, method 800 is not limited to that example embodiment.

In 802, query pre-processor 302 of knowledge resource retriever 112 may receive a query 310 for knowledge resources from one or more knowledge bases 106, wherein the query comprises one or more search terms. In an embodiment, each of the knowledge resources comprises at least one of a set of instructions for rectifying issues in a computing system, or knowledge base articles comprising solutions for rectifying the issues in the computing system.

In 804, lexical retriever engine 404 may obtain, based on query 310 (or pre-processed query 410), a first set of candidate resources from the one or more knowledge bases 106 having a lexical similarity to the one or more search terms.

In 806, semantic retriever engine 406 may obtain, based on query 310 (or pre-processed query 411), a second set of candidate resources from the one or more knowledge bases 106 having a lexical similarity to the one or more search terms.

In 808, ranker engine 306 may, for each of the first set of candidate resources and the second set of candidate resources, determine a level of confidence 608 indicating a relevance of the candidate resource to query 310.

In 810, ranker engine 306 may rank the first set of candidate resources and the second set of candidate resources based on at least level of confidence 608 determined for each of the first set of candidate resources and the second set of candidate resources to generate a ranked list of candidate resources 606. In an embodiment, aggregator 308 may re-order the ranked list of candidate resources 606 based on metadata 706. For instance, aggregator 308 may obtain metadata 706 associated with the first set of candidate resources and the second set of candidate resources, and re-rank (e.g., re-order) the first set of candidate resources and the second set of candidate resources (i.e., ranked list of candidate resources 606) based on level of confidence 608 determined for each of the first set of candidate resources and the second set of candidate resources and metadata 706. In an embodiment, the metadata comprises at least one of an age of each candidate resource of the first set of candidate resources and the second set of candidate resources, and a usage frequency of each candidate resource of the first set of candidate resources and the second set of candidate resources. It is noted that aggregator 308 may re-order the ranked list of candidate resources 606 based on additional criteria, including, but not limited to, scores 608, 702, and 704. For instance, Scores 608, 702, 704, and/or metadata 706 may be combined in a weighted manner to determine a final hybrid score utilized to re-reorder the ranked list of candidate resources 606.

In 812, aggregator 308 may provide a response to query 310 comprising at least a subset of the ranked list candidate resources 606 to a graphical user interface (e.g., GUI screen 200) for display thereby.

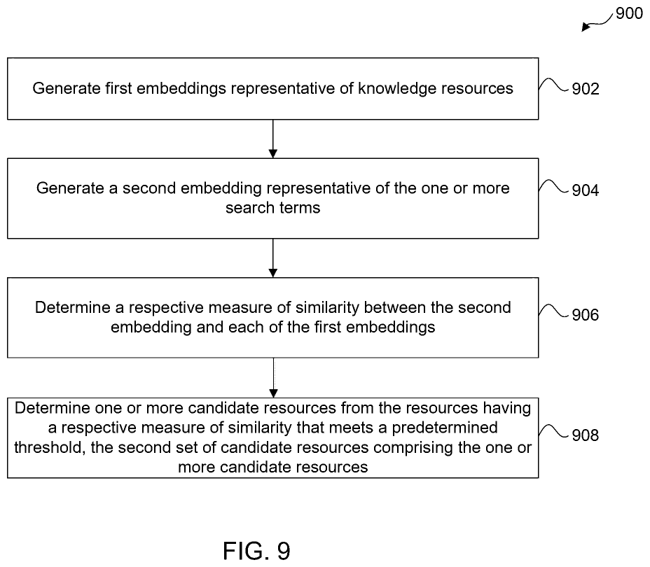

FIG. 9 is a flowchart for a method 900 for obtaining the second set of candidate resources, according to some embodiments. Method 900 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 9, as will be understood by a person of ordinary skill in the art.

Method 900 shall be described with reference to FIG. 4. However, method 900 is not limited to that example embodiment.

In 902, multi-phased trained language model 408 of semantic retriever engine 406 may generate first embeddings representative of the knowledge resources. The first embeddings may be stored in vector store 402

In 904, multi-phased trained language model 408 may generate a second embedding representative of the one or more search terms (e.g., of query 410). In an embodiment, the first embeddings and the second embedding are generated utilizing one or more language models. In an embodiment, the one or more language models comprise a first transformer-based language model and a second transformer-based language model.

In 906, semantic retriever engine 406 may determine a respective measure of similarity (e.g., a cosine similarity) between the second embedding and each of the first embeddings.

In 908, semantic retriever engine 406 may determine one or more candidate resources from the resources having a respective measure of similarity that meets a predetermined threshold (e.g., greater than or equal to 0.80), the second set of candidate resources comprising the one or more candidate resources.

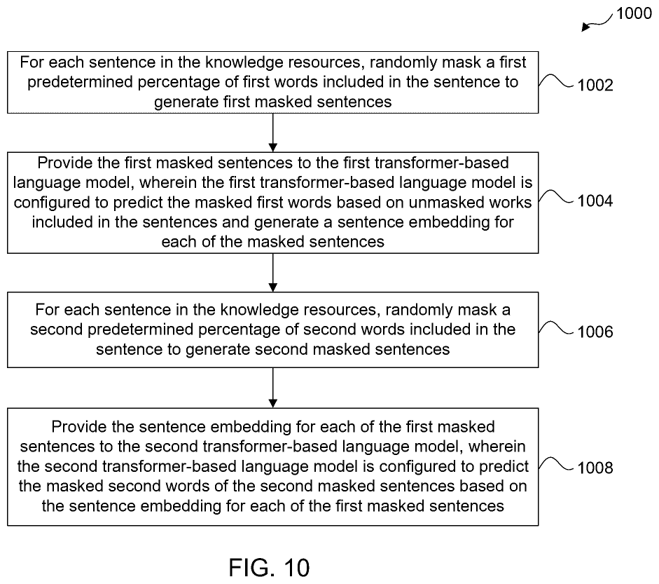

FIG. 10 is a flowchart for a method 1000 for training language model(s), according to some embodiments. Method 1000 can be performed by processing logic that can comprise hardware (e.g., circuitry, dedicated logic, programmable logic, microcode, etc.), software (e.g., instructions executing on a processing device), or a combination thereof. It is to be appreciated that not all steps may be needed to perform the disclosure provided herein. Further, some of the steps may be performed simultaneously, or in a different order than shown in FIG. 10, as will be understood by a person of ordinary skill in the art.

Method 1000 shall be described with reference to FIGS. 4 and 5. However, method 1000 is not limited to that example embodiment.

In 1002, semantic retriever engine 406 may train the first transformer-based language model (e.g., encoder 502 of BERT model 412) by, for each sentence in the knowledge resources, randomly masking a first predetermined percentage of first words included in the sentence to generate first masked sentences 506.

In 1004, semantic retriever engine 406 may provide first masked sentences 506 to the first transformer-based language model (e.g., encoder 502 of BERT model 412), wherein the first transformer-based language model (e.g., encoder 502 of BERT model 412) is configured to predict the masked first words based on unmasked words included in the sentences and generate a sentence embedding for each of the first masked sentences.

In 1006, semantic retriever engine 406 may train the second transformer-based language model (e.g., decoder 510 of RetroMAE model 414) by, for each sentence in the knowledge resources, randomly masking a second predetermined percentage of second words included in the sentence to generate second masked sentences 512. In an embodiment, the second predetermined percentage is greater than the first predetermined percentage.

In 1008, semantic retriever engine 406 may provide the sentence embedding for each of the first masked sentences to the second transformer-based language model (e.g., decoder 510 of RetroMAE model 414), wherein the second transformer-based language model (e.g., decoder 510 of RetroMAE model 414) is configured to predict the masked second words of the second masked sentences based on the sentence embedding for each of first masked sentences 506.

Various embodiments may be implemented, for example, using one or more well-known computer systems, such as computer system 1100 shown in FIG. 11. One or more computer systems 1100 may be used, for example, to implement any of the embodiments discussed herein, as well as combinations and sub-combinations thereof.

Computer system 1100 may include one or more processors (also called central processing units, or CPUs), such as a processor 1104. Processor 1104 may be connected to a communication infrastructure or bus 1106.

Computer system 1100 may also include user input/output device(s) 1103, such as monitors, keyboards, pointing devices, etc., which may communicate with communication infrastructure 1106 through user input/output interface(s) 1102.

One or more of processors 1104 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1100 may also include a main or primary memory 1108, such as random access memory (RAM). Main memory 1108 may include one or more levels of cache. Main memory 1108 may have stored therein control logic (i.e., computer software) and/or data.

Computer system 1100 may also include one or more secondary storage devices or memory 1110. Secondary memory 1110 may include, for example, a hard disk drive 1112 and/or a removable storage device or drive 1114. Removable storage drive 1114 may be a floppy disk drive, a magnetic tape drive, a compact disk drive, an optical storage device, tape backup device, and/or any other storage device/drive.

Removable storage drive 1114 may interact with a removable storage unit 1118. Removable storage unit 1118 may include a computer usable or readable storage device having stored thereon computer software (control logic) and/or data. Removable storage unit 1118 may be a floppy disk, magnetic tape, compact disk, DVD, optical storage disk, and/any other computer data storage device. Removable storage drive 1114 may read from and/or write to removable storage unit 1118.

Secondary memory 1110 may include other means, devices, components, instrumentalities or other approaches for allowing computer programs and/or other instructions and/or data to be accessed by computer system 1100. Such means, devices, components, instrumentalities or other approaches may include, for example, a removable storage unit 1122 and an interface 1120. Examples of the removable storage unit 1122 and the interface 1120 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1100 may further include a communication or network interface 1124. Communication interface 1124 may enable computer system 1100 to communicate and interact with any combination of external devices, external networks, external entities, etc. (individually and collectively referenced by reference number 1128). For example, communication interface 1124 may allow computer system 1100 to communicate with external or remote devices 1128 over communications path 1126, which may be wired and/or wireless (or a combination thereof), and which may include any combination of LANs, WANs, the Internet, etc. Control logic and/or data may be transmitted to and from computer system 1100 via communication path 1126.

Computer system 1100 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1100 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1100 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1100, main memory 1108, secondary memory 1110, and removable storage units 1118 and 1122, as well as tangible articles of manufacture embodying any combination of the foregoing. Such control logic, when executed by one or more data processing devices (such as computer system 1100), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 11. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method, comprising:
receiving a query for knowledge resources from one or more knowledge bases, wherein the query comprises one or more search terms;
obtaining, based on the query, a first set of candidate resources from the one or more knowledge bases having a lexical similarity to the one or more search terms;
obtaining, based on the query, a second set of candidate resources from the one or more knowledge bases having a semantic similarity to the one or more search terms;
for each of the first set of candidate resources and the second set of candidate resources, determining a level of confidence indicating a relevance of the candidate resource to the query;
ranking the first set of candidate resources and the second set of candidate resources based on at least the level of confidence determined for each of the first set of candidate resources and the second set of candidate resources to generate a ranked list of candidate resources; and
providing a response to the query comprising at least a subset of the ranked list candidate resources to a graphical user interface for display thereby.

2. The computer-implemented method of claim 1, wherein obtaining the second set of candidate resources comprises:
generating first embeddings representative of the knowledge resources;
generating a second embedding representative of the one or more search terms;
determining a respective measure of similarity between the second embedding and each of the first embeddings; and
determining one or more candidate resources from the knowledge resources having a respective measure of similarity that meets a predetermined threshold, the second set of candidate resources comprising the one or more candidate resources.

3. The computer-implemented method of claim 2, wherein the first embeddings and the second embedding are generated utilizing one or more language models.

4. The computer-implemented method of claim 3, wherein the one or more language models comprise a first transformer-based language model and a second transformer-based language model; and
wherein the first transformer-based language model is trained by:
for each sentence in the knowledge resources, randomly masking a first predetermined percentage of first words included in the sentence to generate first masked sentences; and
providing the first masked sentences to the first transformer-based language model, wherein the first transformer-based language model is configured to predict the masked first words based on unmasked words included in the sentences and generate a sentence embedding for each of the first masked sentences; and
wherein the second transformer-based language model is trained by:
for each sentence in the knowledge resources, randomly masking a second predetermined percentage of second words included in the sentence to generate second masked sentences; and
providing the sentence embedding for each of the first masked sentences to the second transformer-based language model, wherein the second transformer-based language model is configured to predict the masked second words of the second masked sentences based on the sentence embedding for each of the first masked sentences.

5. The computer-implemented method of claim 4, wherein the second predetermined percentage is greater than the first predetermined percentage.

6. The computer-implemented method of claim 1, wherein ranking the first set of candidate resources and the second set of candidate resources based on at least the level of confidence determined for each of the first set of candidate resources and the second set of candidate resources to generate the ranked list of candidate resources comprises:
obtaining metadata associated with the first set of candidate resources and the second set of candidate resources; and
ranking the first set of candidate resources and the second set of candidate resources based on the level of confidence determined for each of the first set of candidate resources and the second set of candidate resources and the metadata.

7. The computer-implemented method of claim 6, wherein the metadata comprises at least one of:
an age of each candidate resource of the first set of candidate resources and the second set of candidate resources; and
a usage frequency of each candidate resource of the first set of candidate resources and the second set of candidate resources.

8. The computer-implemented method of claim 1, wherein each of the knowledge resources comprises at least one of:
a set of instructions for rectifying issues in a computing system; or
knowledge base articles comprising solutions for rectifying the issues in the computing system.

9. A system, comprising:
a memory; and
at least one processor coupled to the memory and configured to:
receive a query for knowledge resources from one or more knowledge bases, wherein the query comprises one or more search terms;
obtain, based on the query, a first set of candidate resources from the one or more knowledge bases having a lexical similarity to the one or more search terms;
obtain, based on the query, a second set of candidate resources from the one or more knowledge bases having a semantic similarity to the one or more search terms;
for each of the first set of candidate resources and the second set of candidate resources, determine a level of confidence indicating a relevance of the candidate resource to the query;
rank the first set of candidate resources and the second set of candidate resources based on at least the level of confidence determined for each of the first set of candidate resources and the second set of candidate resources to generate a ranked list of candidate resources; and
provide a response to the query comprising at least a subset of the ranked list candidate resources to a graphical user interface for display thereby.

10. The system of claim 9, wherein, to obtain the second set of candidate resources, the at least one processor is configured to:
generate first embeddings representative of the knowledge resources;
generate a second embedding representative of the one or more search terms;
determine a respective measure of similarity between the second embedding and each of the first embeddings; and
determine one or more candidate resources from the knowledge resources having a respective measure of similarity that meets a predetermined threshold, the second set of candidate resources comprising the one or more candidate resources.

11. The system of claim 10, wherein the first embeddings and the second embedding are generated utilizing one or more language models.

12. The system of claim 11, wherein the one or more language models comprise a first transformer-based language model and a second transformer-based language model; and
wherein, to train the first transformer-based language model, the at least one processor is configured to:
for each sentence in the knowledge resources, randomly mask a first predetermined percentage of first words included in the sentence to generate first masked sentences; and
provide the first masked sentences to the first transformer-based language model, wherein the first transformer-based language model is configured to predict the masked first words based on unmasked words included in the sentences and generate a sentence embedding for each of the first masked sentences; and
wherein, to train the second transformer-based language model, the at least one processor is configured to:
for each sentence in the knowledge resources, randomly mask a second predetermined percentage of second words included in the sentence to generate second masked sentences; and
provide the sentence embedding for each of the first masked sentences to the second transformer-based language model, wherein the second transformer-based language model is configured to predict the masked second words of the second masked sentences based on the sentence embedding for each of the first masked sentences.

13. The system of claim 12, wherein the second predetermined percentage is greater than the first predetermined percentage.

14. The system of claim 9, wherein, to rank the first set of candidate resources and the second set of candidate resources based on at least the level of confidence determined for each of the first set of candidate resources and the second set of candidate resources to generate the ranked list of candidate resources, the at least one processor is configured to:
obtain metadata associated with the first set of candidate resources and the second set of candidate resources; and
rank the first set of candidate resources and the second set of candidate resources based on the level of confidence determined for each of the first set of candidate resources and the second set of candidate resources and the metadata.

15. The system of claim 14, wherein the metadata comprises at least one of:
an age of each candidate resource of the first set of candidate resources and the second set of candidate resources; and
a usage frequency of each candidate resource of the first set of candidate resources and the second set of candidate resources.

16. The system of claim 9, wherein each of the knowledge resources comprises at least one of:
a set of instructions for rectifying issues in a computing system; or
knowledge base articles comprising solutions for rectifying the issues in the computing system.

17. A non-transitory computer-readable device having instructions stored thereon that, when executed by at least one computing device, causes the at least one computing device to perform operations, the operations comprising:
receiving a query for knowledge resources from one or more knowledge bases, wherein the query comprises one or more search terms;
obtaining, based on the query, a first set of candidate resources from the one or more knowledge bases having a lexical similarity to the one or more search terms;
obtaining, based on the query, a second set of candidate resources from the one or more knowledge bases having a semantic similarity to the one or more search terms;
for each of the first set of candidate resources and the second set of candidate resources, determining a level of confidence indicating a relevance of the candidate resource to the query;
ranking the first set of candidate resources and the second set of candidate resources based on at least the level of confidence determined for each of the first set of candidate resources and the second set of candidate resources to generate a ranked list of candidate resources; and
providing a response to the query comprising at least a subset of the ranked list candidate resources to a graphical user interface for display thereby.

18. The non-transitory computer-readable device of claim 17, wherein obtaining the second set of candidate resources comprises:
generating first embeddings representative of the knowledge resources;
generating a second embedding representative of the one or more search terms;
determining a respective measure of similarity between the second embedding and each of the first embeddings; and
determining one or more candidate resources from the knowledge resources having a respective measure of similarity that meets a predetermined threshold, the second set of candidate resources comprising the one or more candidate resources.

19. The non-transitory computer-readable device of claim 18, wherein the first embeddings and the second embedding are generated utilizing one or more language models.

20. The non-transitory computer-readable device of claim 19, wherein the one or more language models comprise a first transformer-based language model and a second transformer-based language model; and
wherein the first transformer-based language model is trained by:
for each sentence in the knowledge resources, randomly masking a first predetermined percentage of first words included in the sentence to generate first masked sentences; and
providing the first masked sentences to the first transformer-based language model, wherein the first transformer-based language model is configured to predict the masked first words based on unmasked words included in the sentences and generate a sentence embedding for each of the first masked sentences; and
wherein the second transformer-based language model is trained by:
for each sentence in the knowledge resources, randomly masking a second predetermined percentage of second words included in the sentence to generate second masked sentences; and
providing the sentence embedding for each of the first masked sentences to the second transformer-based language model, wherein the second transformer-based language model is configured to predict the masked second words of the second masked sentences based on the sentence embedding for each of the first masked sentences.
